(19) United States
(12) Patent Application Publication
(10) Pub. No.: US 2026/0300358 A1
(43) Pub. Date: Oct. 1, 2026

(54) DYNAMIC SKILLS-BASED ADVERTISING AND ROUTING FOR ARTIFICIAL INTELLIGENCE AGENTS BASED ON FILTERING OF A SEMANTIC ROUTING SPACE

(71) Applicant: Cisco Technology, Inc., San Jose, CA (US)

(72) Inventors: Eric A. Voit, Bethesda, MD (US); Samer M. Salam, Beirut (LB); Arjun Sambamoorthy, San Jose, CA (US)

(21) Appl. No.: 19/095,172

(22) Filed: Mar. 31, 2025

(51) Int. Cl. G06F 16/335

(52) U.S. Cl. CPC G06F 16/335

(57) ABSTRACT

Skill-based advertising (or registration) and routing across artificial intelligence (AI) agents in a framework based on filtering of a semantic routing space. Local AI agents filter a set of requests or questions that are allowed to be forwarded to remote AI agents via semantic routing. This allows an organization to control forwarding of questions for its overall semantic space, and enables validation of the questions that the remote AI agents are trusted to have jurisdiction. This smooths problematic areas which organizations face when passing questions between the AI agents.

### TECHNICAL FIELD

The present disclosure relates to routing in a multi-agent framework.

### BACKGROUND

As enterprises embrace generative artificial intelligence (AI) to build virtual assistants (or agents), these assistants are specialized in their respective domains in order to offer guarantees on performance metrics, such as precision and reliability. This is accomplished through custom fine-tuned large language models (LLMs), using retrieval-augmented generation (RAG) mechanisms with the proper domain knowledge, or a combination thereof. In order to provide a cohesive customer experience, the specialized agents are interconnected over a fabric that handles request routing from a source agent that receives a user request to a target agent that has the necessary skills to service and answer that request. Each agent may offer its own native user interface, which is typically integrated into one or more of the enterprise products, and can process user queries meant for the agent itself or for remote agents interconnected over the fabric.

For example, multiple virtual assistant agents may each be configured to cover a corresponding topic (e.g., security products, collaboration, networking, etc.). The agents are interconnected in a fabric that supports request routing to the proper agent that can service a user request or query regardless of which source agent interacts with the user. By way of example, a user may be using a networking agent, and has a query regarding firewall policies that needs to be serviced by a security agent.

An approach to route user requests to an appropriate agent is based on semantic similarity in a vector space. Predefined routing policies are registered by listing example utterances (or phrases) for a given routing policy. The degree of similarity of an embedding of the user query is compared to the example utterances for the various predefined routing policies in order to determine a best matching route.

However, the approach does not support routing based on a context absent in the user utterance. For example, an intent such as “which access-point has the highest client density in my network” may need to be routed to different agents depending on the particular network controller used at a customer site. Since the user phrase itself does not provide the controller type context, nor does the phrase indicate which instance(s) of the right controllers to query, request routing based on semantic analysis of phrases/utterances is insufficient.

### BRIEF DESCRIPTION OF THE DRAWINGS

FIG. 1 is a block diagram of an example framework in which request routing may be implemented, according to an example embodiment.

FIG. 2 is a flowchart of a method for routing requests to corresponding agents, according to an example embodiment.

FIG. 3 is a flowchart of a method for processing advertisements based on filtering of a semantic routing space, according to an example embodiment.

FIG. 4 is a flowchart of a method of advertising skills or capabilities based on filtering of a semantic routing space, according to an example embodiment.

FIG. 5 is a flowchart of a method for determining agents to process requests, according to an example embodiment.

FIG. 6A illustrates an example vector space for a source agent for determining agents to process requests, according to an example embodiment.

FIG. 6B illustrates an example vector space for a unified router for determining agents to process requests, according to an example embodiment.

FIG. 7 illustrates a flowchart of a generalized method for routing requests to corresponding agents, according to an example embodiment.

FIG. 8 illustrates a hardware block diagram of a computing device configured to perform functions associated with routing requests to corresponding agents as discussed herein, according to an example embodiment.

### DETAILED DESCRIPTION

### Overview

An example embodiment provides for skill-based advertising (or registration) and routing across artificial intelligence (AI) agents in a framework based on filtering of a semantic routing space. Local AI agents filter a set of requests or questions that are allowed to be forwarded to remote AI agents via semantic routing. This allows an organization to control forwarding of questions for its overall semantic space, and enables validation of the questions that the remote AI agents are trusted to have jurisdiction. This smooths problematic areas which organizations face when passing questions between the AI agents.

### Example Embodiments

An example embodiment enables remote AI agents to advertise supported questions to local AI agents and unified routers. However, the local AI agents and unified routers may selectively support the questions advertised from the remote AI agents. For example, the local AI agents may choose to accept questions about a limited part of a semantic space based on an identity of a remote AI agent. Accordingly, the example embodiment provides a dynamic mechanism for skills advertising (or registration) that may be used for semantic routing of requests in a framework of interconnected AI agents. Each AI agent advertises or registers their skills or capabilities (e.g., a set of user intents and contexts that the AI agent is capable of handling, etc.) based on filtering of a semantic routing space. By way of example, remote AI agents advertise supported questions to local AI agents and unified routers. The example embodiment controls the advertisements to be accepted by the local AI agents, and enables automated acceptance of advertisements to be efficient and concretely measurable. This ensures efficient direct routing of questions for high volume use cases, and use cases going through the unified router. An initial (or source) agent receiving a user request routes the user request to an appropriate target agent for processing based on the skills of the target agent advertised to the initial agent and corresponding to a user intent (or requested functionality) in the request.

It will be appreciated that the techniques of example embodiments may be performed for routing of any types of requests or queries (e.g., for any desired information or actions) to any types of artificial intelligence (AI) or other agents capable of processing the requests. Further, the present embodiments may be applied to any structure, framework, network, fabric, or other arrangement of agents coupled in any fashion. The skills or capabilities of an agent may be based on any attributes pertaining to the types of requests that may be processed by the agent (e.g., products, topics, actions, set of commands, intents, contexts (e.g., network or other environment attributes, etc.), etc.). An intent of an agent may include any natural language or other description of a purpose (or functionality) of the agent. An intent of a request may include any natural language or other description of a purpose (or requested functionality) for the request, while the context may include any attributes pertaining to the request (e.g., item, topic, network or other environment attributes, etc.).

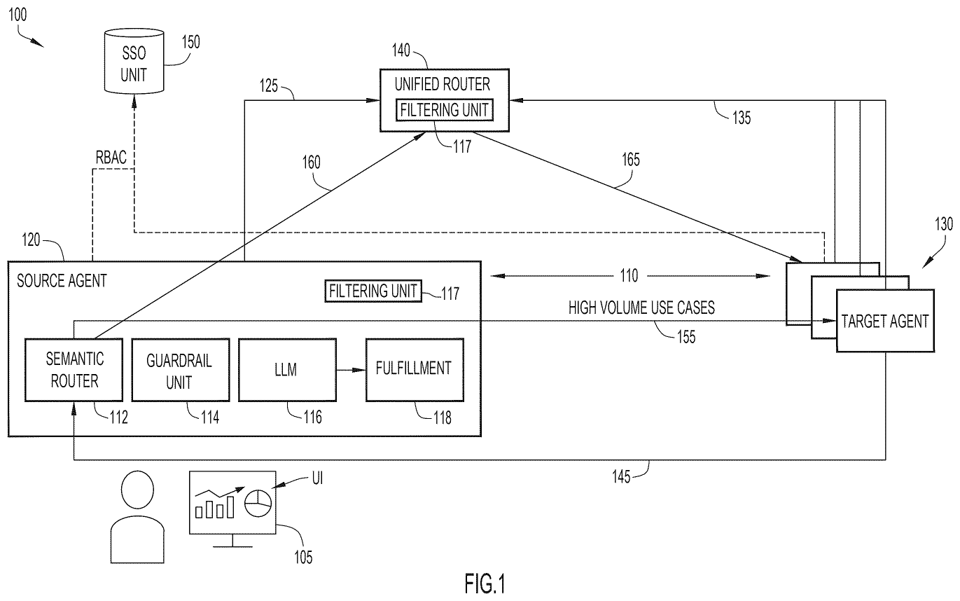

FIG. 1 illustrates an example framework 100 in which an embodiment presented herein may be implemented. Framework 100 includes a plurality of agents 110, a unified router 140, and a single sign-on (SSO) unit 150. The framework may include any structure, framework, network, fabric, or other arrangement with any quantity of agents 110 arranged in any fashion. Each agent 110 includes skills or capabilities to process certain requests or queries (e.g., certain topics, products, actions, set of commands, etc.). By way of example, framework 100 may be employed for a call or support center to provide responses to requests or queries for information for items (e.g., products, services, etc.). However, the framework may be employed for various scenarios. The request preferably includes text (or audio converted to text), while the response may include text (or audio converted from text), figures, diagrams, tables, and/or other visual elements.

The skills or capabilities of agents 110 are dynamically advertised to (or registered with) unified router 140 to enable the unified router to route requests to the appropriate agents for processing. In other words, unified router 140 determines, and routes a request to, one or more agents 110 with sufficient skills or capabilities to process the request. Unified router 140 filters incoming and/or outgoing advertisements as described below. In addition, the skills of certain agents (e.g., handling high volume requests or use cases) may be dynamically advertised to (or registered with) other agents 110 for direct routing of requests (without unified router 140) to those other agents. The routing information for the certain agents may be stored in a cache for rapid access and routing. The advertising or registration is dynamic and may be updated (or performed) as skills or capabilities of agents 110 change and/or new agents 110 are added to framework 100. Single sign-on unit 150 provides any conventional or other security that enables access of the framework and other platforms by a user using a single set of login or other credentials. The security may further provide any conventional or other roles based access control (RBAC, as viewed in FIG. 1) that controls system access for users based on user roles and locations.

Agents 110 may include a source agent 120 that receives a request from an end-user device 105 of a user, and one or more target agents 130 with skills or capabilities to process certain requests or queries (e.g., certain topics, products, actions, set of commands, etc.). Any agents 110 may serve as a source agent 120 and/or target agent 130 to receive and process requests. Source agent 120 provides a user interface (for end-user device 105) to receive requests and provide results for the request. The request preferably includes text (or audio converted to text), while the results preferably include text (or audio converted from text). Further, source agent 120 verifies the user (e.g., via SSO unit 150), and analyzes the request for routing decisions (e.g., routing to unified router 140 and/or appropriate agents 110 (e.g., source agent 120 and/or target agents 130) with sufficient skills or capabilities to process the request). End-user device 105, source agent 120, target agents 130, unified router 140, and SSO unit 150 may be local to each other and/or communicate over a communication network that may include one or more wide area networks (WANs), such as the Internet, and one or more local area networks (LANs). These components may communicate with each other over the communication network using a variety of known or hereafter developed communication protocols.

Source agent 120 includes a semantic router 112, a guardrail unit 114, an LLM 116, and a filtering unit 117. Target agents 130 may be substantially similar to source agent 120 and include these components. Semantic router 112 analyzes a request for routing according to example embodiments as described below. Guardrail unit 114 may monitor the request and results from LLM 116 for malicious queries, queries outside the terms of service, and/or hallucinations (or incorrect or irregular results) from LLM 116 and perform remedial actions (e.g., discard an improper request or irregular results, etc.) via any conventional or other techniques. Filtering unit 117 filters advertisements received and/or sent by source agent 120 to control a semantic space as described below.

LLM 116 processes a request and produces results or fulfillment 118 when source agent 120 has sufficient skills or capabilities to process the request. By way of example, LLM 116 may employ any conventional or other large language model (LLM) and natural language processing (NLP) techniques to process the request and provide requested information and/or perform actions. These techniques can parse and understand text, and extract various elements, data types, tasks, and other relevant information. This information can be used to produce results for the request. The LLM may receive a prompt or natural language instruction, and process the prompt to determine the actions to be performed to produce the results. The prompt may include several variations and forms.

However, any quantity of any conventional or other machine learning and/or natural language processing (NLP) models may be used (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to provide the corresponding skills or capabilities for handling certain requests associated with an agent 110 (e.g., certain topics, products, actions, set of commands, etc.).

For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., request/query, etc.) as input and corresponding desired outputs (e.g., results for requests or queries, actions to perform to retrieve results for requests or queries, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., results for requests or queries, actions to perform to retrieve results for requests or queries, etc.). The output with the highest probability may be selected as the result.

Source agent 120 advertises or registers its skills or capabilities with unified router 140 at flow 125, while target agents 130 advertise or register their skills or capabilities with unified router 140 at flows 135. In addition, certain target agents 130 (e.g., handling high volume requests or use cases, etc.) may advertise or register their skills or capabilities with source agent 120 at flow 145. Target agents 130 may advertise or register their skills or capabilities directly with source agent 120 (e.g., for data privacy, etc.) or through unified router 140. The high volume use cases may be determined based on a quantity of cases (or specific types of requests) processed by source or target agents 120, 130 satisfying a threshold. In addition, an agent 110 (e.g., source agent 120 and target agent 130) may advertise or register its skills or capabilities (and/or skills or capabilities of its peer (or neighboring) agents) to indicate the skills or capabilities accessible through the agent. Filtering unit 117 of agent 110 (e.g., source agent 120 or target agent 130) and unified router 140 filters incoming and/or outgoing advertisements based on regions of a semantic routing space assigned to agents 110 as described below.

Source agent 120 may receive a request from end-user device 105. Semantic router 112 of source agent 120 analyzes the request to render routing decisions. For example, semantic router 112 may determine that source agent 120 has sufficient skills or capabilities to process the request. In this case, the request is processed by LLM 116 of source agent 120, and the results are returned to end-user device 105.

When semantic router 112 of source agent 120 determines that one or more target agents 130 registered with source agent 120 have sufficient skills or capabilities to process the request, semantic router 112 directly routes the request from source agent 120 to the determined target agents for processing at flow 155. The determined target agents process the request (e.g., via their corresponding LLMs 116 in substantially the same manner described above) and return results to source agent 120. The source agent combines the results from the target agents and provides an overall result to end-user device 105.

When semantic router 112 of source agent 120 determines that neither source agent 120 nor target agents 130 registered with source agent 120 have sufficient skills or capabilities to process the request, semantic router 112 of source agent 120 routes the request to unified router 140 at flow 160. Since unified router 140 preferably has registrations for all target agents 130 (or a greater quantity of target agents 130 than source agent 120), unified router 140 determines target agents 130 having sufficient skills or capabilities to process the request, and routes the request to the determined target agents at flow 165. The determined target agents process the request (e.g., via their corresponding LLMs 116 in substantially the same manner described above) and return results to unified router 140. Alternatively, the target agent may route the response directly to the source agent, if instructed to do so by the unified router. The unified router provides the results from the determined target agents to source agent 120. The source agent combines the results and provides an overall result to end-user device 105.

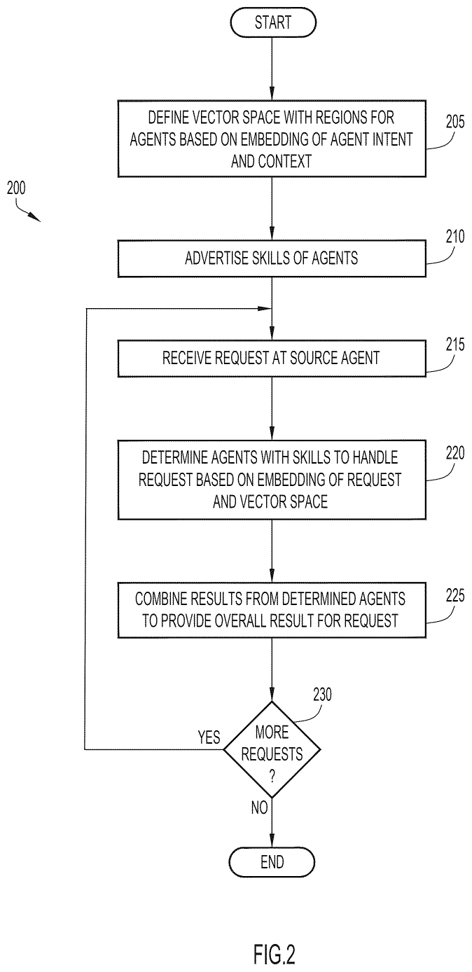

With continued reference to FIG. 1, FIG. 2 illustrates a method 200 for routing requests to corresponding agents, according to an example embodiment. Initially, a vector or multidimensional space is defined based on embeddings of intent and context for each of agents 110 (e.g., (intent, context)-tuples) at operation 205. The intent and context indicate skills or capabilities of an agent 110. Basically, each word or phrase (or tuple) may be represented by a vector (or embedding) having numeric elements corresponding to a plurality of dimensions (of the vector space). Words (or phrases or tuples with) similar meanings have similar word embeddings or vector representations. The word embeddings are produced from machine learning techniques or models (e.g., neural network as described above, etc.) based on an analysis of word usage in a collection of text or documents. The embeddings or vector representations may be pre-existing, and/or produced using any conventional or other tools or techniques (e.g., GLOVE, WORD2VEC, SBERT, etc.).

The dimensions of the embeddings correspond to dimensions of the vector space to map the embeddings to the vector space. In other words, an embedding may serve as coordinates in the vector space to identify a location in the vector space for the embedding (e.g., intent and context, etc.). The collective (intent, context) embeddings of each agent 110 occupy a corresponding discrete region in the vector space. The region may include two or more dimensions. By way of example, the region includes a convex polytope (e.g., n-dimensional generalization of a convex polygon within that n-dimensional space). In an example embodiment, the polytopes can be n-dimensional hypercubes. In other words, each region defines the entire set of skills or capabilities (e.g., intents, contexts, etc.) for a corresponding agent 110 and, thus, represents the boundary of the agent skills or capabilities. The regions of agents 110 may overlap which enables user requests to be multicast to, and processed by, more than one agent 110 as described below.

For example, an agent 110 can have each supported intent and context (e.g., skill or capability) indicated by a vector (or embedding) of ranges defined by minimum and maximum values for each dimension (e.g., based on different terminology or expressions for the intent and context, etc.). By way of example, a vector of n dimensions may be expressed as: {[dimension 1 (minimum value, maximum value)], [dimension 2 (minimum value, maximum value)], . . . [dimension n (minimum value, maximum value]}.

The totality of requests or queries which can be answered by a specific agent 110 may be represented as a set of these vectors (which define the boundaries of the region for the agent in the multidimensional or vector space). The set of vectors enables determination of whether a request or query is within the purview of skills or capabilities of a specific agent. By way of example, a request may be encoded as a single n-dimensional request vector (or embedding) in substantially the same manner described above. The request vector may be expressed as: {[dimension1], [dimension 2], . . . , [dimension n] }. The determination may be accomplished by numerical comparisons which check whether the dimensions of the request vector are within the dimension ranges (of the set of vectors) for the intents and contexts supported by an agent.

The skills or capabilities of an agent 110 may be based on any attributes pertaining to the types of requests that may be processed by the agent (e.g., products, topics, actions, set of commands, intents, contexts (e.g., network or other environment attributes, etc.), etc.). An intent of an agent 110 may include any natural language or other description of a purpose (or functionality) of the agent. By way of example, the skills or capabilities (e.g., intent and context, etc.) for an agent 110 may include client IP address pools for each managed virtual routing and forwarding (VRF) for a network macro-segment, network device IP address pools (e.g., for NetOps device management), geographic segmentation (e.g., an area under responsibility of a network controller), various tenants supported within a network controller datastore, different services maintained for service level agreements (SLAs) (e.g., level 2 VPN (L2VPN), level 3 VPN (L3VPN), etc.), and/or namespace division (e.g., context of managed objects under a network controller). Embeddings for one or more of these intents and contexts for an agent 110 may be generated to determine the region in the vector space indicating the boundary of skills or capabilities for the agent.

Agents 110 and/or unified router 140 dynamically advertise or register skills or capabilities with peer (or neighboring) agents and/or unified routers 140 at operation 210. Target agents 130 may advertise or register with source agent 120 for high volume use cases. Target agents 130 may advertise or register their skills or capabilities directly with source agent 120 (e.g., for data privacy, etc.) or through unified router 140. The target agents may filter the advertisements to provide certain advertisements to source agent 120. The high volume use cases may be determined based on a quantity of cases (or specific types of requests) processed by source or target agents 120, 130 satisfying a threshold. The high volume use cases may be supported differently based on an identity of the source agent receiving the registration. This effectively enables custom behavior from a target agent 130 on answers to specific types of requests or queries based on the source agent 120 providing the query. Advertising or registration may be accomplished by an agent 110 providing bounds of the corresponding region in the vector space (defining the corresponding skills or capabilities) to another agent 110 and/or unified router 140. A unified router 140 may advertise or register corresponding skills or capabilities of associated agents 110 by providing bounds of the corresponding regions in the vector space (e.g., actual or aggregated bounds) to peer (or neighboring) agents 110 and/or unified routers 140. The bounds may be represented by the set of vectors described above or by any quantity of any types of coordinate values in the vector space to indicate the boundaries of the region.

Agents 110 and/or unified router 140 receiving the advertisement may filter the advertisement, accept the advertisement based on the filtering, and update the routing information accordingly. Further, agents 110 and/or unified router 140 sending the advertisement may filter the advertisement for advertising specific skills or capabilities to specific agents and/or unified routers. When common embeddings are used, different organizations can quickly peer on the types of questions supported numerically without passing and tweaking large sets of sample questions. This improves load balancing where instance data (e.g., ranges of IP addresses supported) may change, and continually retraining supported questions is not practical. Further, a troubleshooting process is simplified since target agents 130 know which questions qualify as supported on a source agent based on an accepted common/known semantic embedding.

A user request from an end-user device 105 is received at a source agent 120 at operation 215. Semantic router 112 of source agent 120 analyzes the request to render routing decisions for determining agents (e.g., source agent 120 and target agents 130) with sufficient skills or capabilities to process the request at operation 220. For example, semantic router 112 of source agent 120 determines an embedding of the request (e.g., embedding of intent (or desired functionality) and context within the request), and identifies potential regions within a vector space for the source agent and/or target agents 130 registered with the source agent that encompass the embedding of the request. The intent and context of the request may be determined using any conventional or other natural language processing (NLP) techniques. When the region of source agent 120 is identified, the source agent may process the request (e.g., via LLM 116) to produce results. In other words, if the coordinates of the vector representing the embedding of the user request fall or reside within the region of the source agent, then the source agent may process the request.

When one or more regions of target agents 130 registered with source agent 120 are identified, source agent 120 directly routes or sends the request to the target agents associated with the one or more identified regions to process the request (e.g., via corresponding LLMs 116 of the target agents). In other words, if the coordinates of the vector representing the embedding of the user request fall or reside within the regions of one or more target agents, then the one or more target agents may process the request. The results of the request from target agents 130 are returned to source agent 120.

In the event that the embedding of the request resides outside the regions of source agent 120 and the target agents 130 registered with the source agent (e.g., source agent 120 is unable to identify a region or agent), the request is routed or sent by source agent 120 to unified router 140. Since unified router 140 preferably has registrations for all target agents 130 (or a quantity of target agents 130 greater than source agent 120), unified router 140 identifies the one or more regions in the vector space for the target agents encompassing the embedding of the request. When no regions can be identified (e.g., no regions encompass the embedding of the request), a closest or nearest region may be identified. Unified router 140 routes or sends the request to the target agents 130 associated with the one or more identified regions to process the request (e.g., via corresponding LLMs 116 of the target agents). The results of the request are returned from target agents 130 to unified router 140 and provided to source agent 120. This technique allows a cut-through mode from source agent 120 directly to target agents 130 for high volume requests, while maintaining unified router 140 as a default gateway for routing requests to target agents 130 whose skills are not known to source agent 120.

The results from the identified agents (or unified router 140) are combined by source agent 120 to produce an overall result at operation 225 that is provided to end-user device 105 in response to the request. The above process is repeated from operation 215 for additional requests until the requests have been processed as determined at operation 230.

Framework 100 may be scaled to large network environments. In an embodiment, framework 100 may include agents 110 and unified router 140 in a wide area network environment. In this case, unified router 140 may include one or more DNS servers or other directory systems to expand the scale of framework 100. Unified router 140 may filter incoming and/or outgoing advertisements in substantially the same manner described herein to maintain region boundaries and IP addresses (and/or other information) for agents 110. Unified router 140 receives the request form source agent 120 and identifies one or more regions in the vector space for the target agents encompassing the embedding of the request in substantially the same manner described herein. Unified router 140 provides information for the target agents associated with the one or more identified regions (e.g., IP or other network address, agent identity, corresponding region or polytope, etc.) to source agent 120.

Source agent 120 generates a query for unified router 140 to identify one or more target agents 130 capable of handling the request. By way of example, the query may be included within a packet with a modified DNS query message. Basically, the conventional DNS query message is modified to include an embedding object. The embedding object includes the embedding of a request for identifying one or more target agents 130. By way of further example, the response from unified router 140 may be included within a packet with a modified DNS response message. Basically, the conventional DNS response message is modified by including an embedding object and a region object. The embedding object includes the embedding of a request for identifying one or more target agents 130. The region object includes the region (or polytope) boundaries of the remote target agent identified for the request.

The source agent routes or sends the request to the target agents 130 based on the information from unified router 140 to process the request (e.g., via corresponding LLMs 116 of the target agents). Alternatively, unified router 140 may route the requests to the target agents associated with the one or more identified regions. The results of the request are returned from target agents 130 to source agent 120. Alternatively, the target agents may provide the response to unified router 140 for forwarding to source agent 120, when unified router 140 routes the request. The results from the identified agents (or unified router 140) are combined by source agent 120 to produce an overall result that is provided to end-user device 105 in response to the request.

In an embodiment, framework 100 may include agents 110 and unified router 140 in a wide area network environment and advertise the skills or capabilities via a network routing protocol configured for semantic routing. Unified router 140 may filter incoming and/or outgoing advertisements in substantially the same manner described herein. In this case, the network routing protocol enables multi-hop routing of requests from a source agent to target agents within the same or different domains. Further, unified router 140 may aggregate the region boundaries received in advertisements from associated agents 110 within a domain to produce a summary for advertising to external domains having their own unified routers (e.g., to hide identities of the agents from external domains which have a lesser level of trust). Thus, the unified router may serve as a gateway for accessing the skills or capabilities of the associated agents. This enables the unified router to own the business relationship of how to reach the associated agents. Effectively, the unified router is the middleman which simplifies access to the associated agents

By way of example, the summary may include a range for each dimension of region (or polytope) boundaries, where the range comprises the largest maximum value and lowest minimum value for that dimension from the advertisements (or skills or capabilities of the agents). Further, groups or communities of polytopes that are similar may be identified and combined or aggregated for the summary. In addition, any conventional or other principal component analysis (PCA) may be employed to determine which dimensions of the region boundaries should be combined or aggregated for the summary. PCA basically reduces data dimensions while retaining a maximum amount of information. The determined dimensions of the region boundaries may be combined in substantially the same manner described above (e.g., the range for determined dimensions are provided in the summary and each comprises the largest maximum value and lowest minimum value for that determined dimension from the advertisements, etc.).

The network routing protocol may be any conventional or other routing protocol (e.g., Border Gateway Protocol (BGP), Open Shortest Path First (OSPF), Interior Gateway Protocol (IGP), Intermediate System to Intermediate System, etc.) adapted or modified for semantic routing (e.g., advertises polytope boundaries representing skills or capabilities of the agents instead of, or in addition to, IP or other addresses). By way of example, a BGP-based protocol may be used to advertise routes to answer specific questions via the range based polytopes. Accordingly, the embodiment modifies an update message of BGP to carry the polytope ranges representing skills or capabilities of the agents. For example, a conventional BGP update message may be modified by adding new or additional type/length/values (TLVs) to enable exchange of polytope ranges (e.g., upper/lower ranges for polytope dimensions) within the update message. The polytope TLVs may be employed in a prefix descriptors field of a prefix section of the modified BGP update message to indicate presence of polytope ranges within the message. The polytope ranges may be stored in the value portion of the prefix descriptors field.

By way of further example, an OSPF-based network routing protocol may be employed. The individual intents supported by a specific agent is described by an OSPF-based or modified link state advertisement (LSA) indicating each intent supported via n-dimensional vector (or polytope) ranges. For example, the polytope ranges may be included within an OSPF-based packet. A conventional OSPF packet may be modified where LSA data includes polytope ranges.

In addition, an embodiment may employ plural network routing protocols. A mix of BGP, OSPF, and other network routing protocol mechanisms may be employed to interchange polytope information at protocol peering points. This enables mixing of the strengths of the network routing protocols. For example, a first (e.g., BGP-based, etc.) protocol may be employed for inter-domain routing, while a second (e.g., OSPF-based, Intermediate System to Intermediate System-based, IGP-based, etc.) protocol may be used for intra-domain routing in substantially the same manners described above.

An agent 110 or unified router 140 receives the request and identifies one or more regions in the vector space for the target agents encompassing the embedding of the request in substantially the same manner described herein. The agent or unified router sends or routes the request to the target agents to process the request (e.g., via corresponding LLMs 116 of the target agents). The results of the request are returned from the target agents or unified router to source agent 120. The results from the target agents (or unified router 140) are combined by source agent 120 to produce an overall result that is provided to end-user device 105 in response to the request.

With continued reference to FIGS. 1 and 2, FIG. 3 illustrates a method 300 for processing advertisements based on filtering of a semantic routing space, according to an example embodiment. This may correspond to operation 210 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above. Agents 110 dynamically advertise or register their skills with other agents and/or unified router 140 in substantially the same manner described above (e.g., an agent 110 providing bounds of the corresponding region in the vector space to another agent and/or unified router 140). Unified router 140 may dynamically advertise or register the skills or capabilities of associated agents (and/or unified routers) with other agents and/or unified routers in substantially the same manner described above (e.g., a unified router 140 providing bounds of the corresponding regions (e.g., actual or aggregated) in the vector space to peer (or neighboring) agents 110 and/or unified routers 140).

A receiving node (e.g., an agent 110, a unified router 140, etc.) receives an advertisement from an advertising node (e.g., agent 110, unified router 140, etc.) at operation 305. The advertisement includes region or polytope boundaries indicating the skills or capabilities of (or accessible through) the advertising node. When the receiving node is not configured to perform filtering as determined at operation 310 (e.g., a parameter may be used to enable or disable filtering, etc.), the receiving node accepts the advertisement and updates routing information accordingly at operation 330. For example, the receiving node may update the routing information to reflect the region boundaries of the advertising node indicating the advertised skills or capabilities in substantially the same manner described below. This enables the receiving node to route requests encompassed by the region boundaries to the advertising node.

When the receiving node is configured to perform filtering as determined at operation 310 (e.g., a parameter may be used to enable or disable filtering, etc.), the receiving node obtains semantic ranges (or region or polytope boundaries) for the advertising node at operation 315. The semantic ranges may indicate subject matter for which the advertising node may (or is trusted to) handle requests, and/or the desired skills or capabilities of the advertising node for handling requests (e.g., the semantic range may indicate a subset of the skills or capabilities of the advertising node, etc.). The semantic ranges may be pre-configured for each node, or may be dynamically determined.

Initially, an agent 110 maintains regions of the embedding vector space for which the agent may answer questions. This can be defined as an aggregate of polytope boundaries of the collective set of skills or capabilities of the agent and peer agents advertising to the agent. Any embedding representation may be used to define the vector space, provided that the same embedding is consistently used among the agents (and unified router). A default route may be added to a semantic routing table for the aggregated polytope boundaries (e.g., indicating routing information and polytope boundaries for corresponding agents). Questions with embeddings within the aggregated semantic space but not answerable locally (e.g., based on a comparison of the question embedding to agent polytope boundaries) are forwarded to the unified router. Questions with embeddings outside the entirety of the aggregated semantic space are declined.

An agent 110 maintains a subset of the aggregated polytope indicating other agents to send questions. This defines the domain of questions that the agent prefers for high volume local redirection. This subset may be constrained by defining allowed polytope ranges for specific target agents. This allows defining the target agents that the agent knows or trusts to provide relevant answers on specific topics. The definitions (or semantic ranges) are generated using known embeddings in common with the target agents.

Further, unified router 140 (and/or one or more other central authorities) may manage local polytope filters as an organizational policy so that requests handled by agents 110 are centrally controlled (rather than distributed to each agent). Thus, unified router 140 (and/or one or more other central authorities) may provide semantic ranges for agents to control which requests are handled by those agents.

Moreover, the semantic ranges may be obtained based on a trusted authority (e.g., third party service, etc.). The trusted authority may provide an indication of the skills or capabilities of the agent that are trusted or verified (e.g., based on historical data, etc.). The skills or capabilities may be indicated by, or converted to, semantic ranges. Further, rights of the agent to advertise the specific skills or capabilities may be determined by the trusted authority. This matters since skills can include instance data, such as IP address ranges. This also allows the legitimacy of the advertised skills or capabilities to be verified prior to installing the skill in the semantic routing table. For example, a mechanism may track skills or capabilities (semantic ranges) asserted by one or more external authorities (e.g., trusted authorities (e.g., agents, unified routers, etc.) known to possess (or have access to) the asserted skills or capabilities). The rights of an agent to advertise may be based on the skills or capabilities asserted by the external authorities (e.g., another agent may not be authorized to advertise the asserted skills or capabilities). This enhances security against agents who may fraudulently advertise skills or capabilities for malicious purposes (e.g., to attract traffic, etc.).

The receiving node verifies the skills or capabilities in the advertisement at operation 320. For example, the region or polytope boundary of the skills or capabilities in the advertisement are compared to the semantic ranges obtained for the advertising node. The advertisement is considered valid when the semantic ranges for the advertising node encompass the polytope boundaries of the advertisement. By way of example, the advertisement may be verified when each dimension of the advertised polytope boundaries resides within each range for the dimension of the obtained semantic ranges for the advertising node. Further, a distance (e.g., Euclidean distance, etc.) or cosine similarity value may be determined between the advertised polytope boundaries and obtained semantic ranges. The advertisement may be verified when the distance or cosine similarity values satisfy a threshold. In addition, any conventional or other principal component analysis (PCA) may be employed to determine which dimensions of the advertised polytope boundaries and obtained semantic ranges should be compared. PCA basically reduces data dimensions while retaining a maximum amount of information. The determined dimensions of the advertised polytope boundaries and obtained semantic ranges may be compared in substantially the same manner described above (e.g., advertised polytope residing within all sematic ranges, a VectorDB or other search, cosine similarity, etc.).

When the advertisement is not verified as determined at operation 325, the advertisement is discarded at operation 335.

When the advertisement is verified as determined at operation 325, the advertisement is accepted and routing information is updated accordingly at operation 330. For example, the receiving node may update the routing information to reflect the region boundaries of the advertising node indicating the advertised skills or capabilities. This enables the receiving node to route requests encompassed by the region boundaries to the advertising node.

By way of example, the receiving node may determine an intersection of the semantic ranges for the advertising node and the advertised polytope boundaries (e.g., minimum for the respective lowest and highest values for each dimension in the advertised polytope boundaries within the semantic ranges) to produce a resulting semantic range for the advertising node. This defines the semantic space where question forwarding is supported from the receiving node to the advertising node. The receiving node may update the routing information to reflect the semantic range for the advertising node indicating the skills or capabilities for the advertising node. For example, the advertising node may advertise a specific knowledge within the semantic range for answering questions, where the intersection represents this knowledge (or subset of the semantic range).

Further, additional filters based on a cost for remotely handling of a question can be associated with sub-ranges of the advertised polytope boundaries. The cost (and associated range of the skills or capabilities) may be included within the advertisement. For example, the skills or capabilities within the semantic ranges for an advertising node that incur a high cost (e.g., greater than a threshold, etc.) may be removed or pruned from the semantic ranges for the advertising node (e.g., the semantic ranges may be adjusted to omit a range of the skills or capabilities incurring a high cost, etc.). The receiving node can also filter out specific ranges from the semantic routing table where an advertised cost is deemed unaffordable by the receiving node (e.g., the cost is greater than a threshold, etc.).

Once the advertisement has been accepted at operation 330 or discarded at operation 335, the above process repeats from operation 305 until the advertisements have been processed as determined at operation 340.

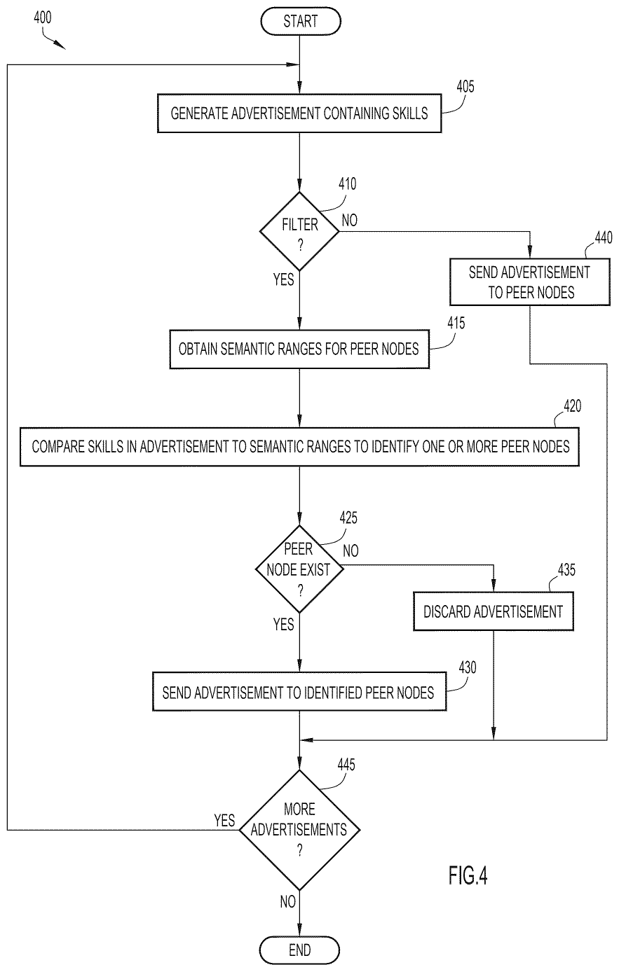

An advertising node (e.g., agent 110, unified router 140, etc.) may determine its own polytope intersection in order to advertise support of specific question sets to specific receiving nodes. With continued reference to FIGS. 1-3 , FIG. 4 illustrates a method 400 of advertising skills or capabilities based on filtering of a semantic routing space, according to an example embodiment. This may correspond to operation 210 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above.

Agents 110 dynamically advertise or register their skills with other agents and/or unified router 140 in substantially the same manner described above (e.g., an agent 110 providing bounds of the corresponding region in the vector space to another agent and/or unified router 140). Unified router 140 may dynamically advertise or register the skills or capabilities of associated agents (and/or unified routers) with peer (or neighboring) agents and/or unified routers in substantially the same manner described above (e.g., a unified router 140 providing bounds of the corresponding regions (e.g., actual or aggregated) in the vector space to peer (or neighboring) agents 110 and/or unified routers 140).

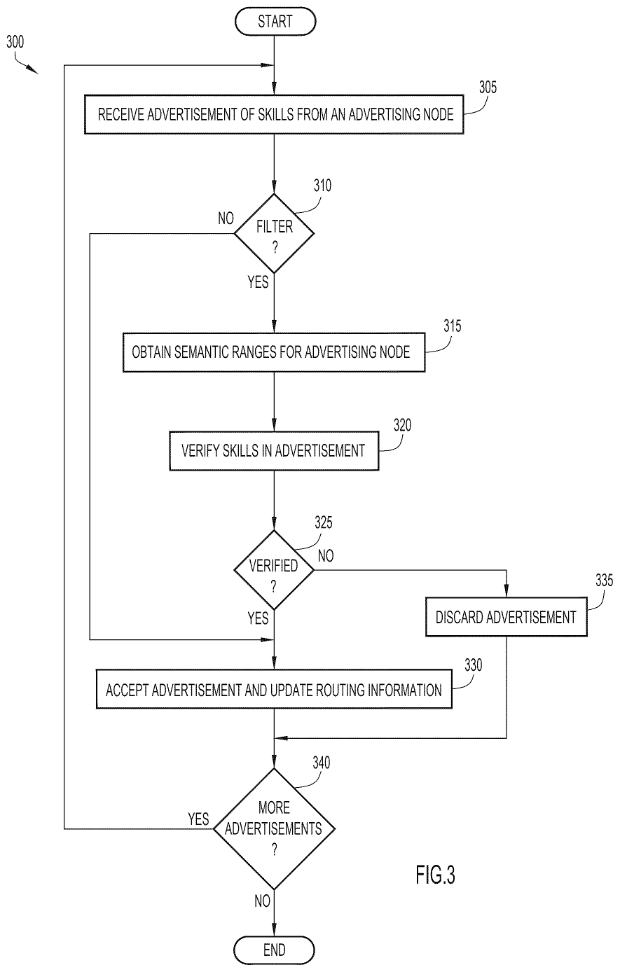

An advertising node (e.g., an agent 110, a unified router 140, etc.) generates an advertisement at operation 405. The advertisement includes region or polytope boundaries indicating the skills or capabilities provided by (or accessible through) the advertising node. The advertisement may further include a cost for utilizing the skills or capabilities to process a request or question. In the case of the advertising node being a unified router 140, the advertisement may include aggregated boundaries for agents 110 (or other unified routers 140) associated with the unified router in substantially the same manner described above. When the advertising node is not configured to perform filtering as determined at operation 410 (e.g., a parameter may be used to enable or disable filtering, etc.), the advertising node sends the advertisement to peer or neighboring nodes (e.g., agents 110, unified routers 140, etc.) at operation 440. The peer nodes may process the advertisement in substantially the same manner described above (FIG. 3).

When the advertising node is configured to perform filtering as determined at operation 410 (e.g., a parameter may be used to enable or disable filtering, etc.), the advertising node obtains semantic ranges (or region or polytope boundaries) for peer (or neighboring) nodes (e.g., agents 110, unified routers 140, etc.) at operation 415. The semantic ranges may indicate subject matter for which the peer nodes may handle requests, and/or the desired skills or capabilities of the peer nodes for handling requests (e.g., a semantic range may indicate a subset of the skills or capabilities of the peer node, etc.). The semantic ranges may be pre-configured for each node, or may be dynamically determined in substantially the same manner described above (e.g., a node may maintain semantic ranges (based on advertisements), a unified router 140 may centrally control the semantic ranges, the semantic ranges may be obtained based on a trusted authority (e.g., third party service, etc.), etc.).

The advertising node compares the region or polytope boundary of the skills or capabilities in the advertisement to the semantic ranges obtained for the peer nodes at operation 420 to identify peer nodes to receive the advertisement. A peer node is identified when the semantic ranges for the peer node encompass the polytope boundaries of the advertisement. By way of example, the peer node may be identified when each dimension of the polytope boundaries in the advertisement resides within each range for the dimension of the region or polytope for a peer node. Further, a distance (e.g., Euclidean distance, etc.) or cosine similarity value may be determined between the polytope boundaries in the advertisement and obtained semantic ranges for peer nodes. The peer node may be identified when the distance or cosine similarity values satisfy a threshold. In addition, any conventional or other principal component analysis (PCA) may be employed to determine which dimensions of the polytope boundaries in the advertisement and obtained semantic ranges should be compared. PCA basically reduces data dimensions while retaining a maximum amount of information. The determined dimensions of the polytope boundaries in the advertisement and obtained semantic ranges may be compared in substantially the same manner described above (e.g., advertised polytope residing within all sematic ranges, a VectorDB or other search, cosine similarity, etc.).

When no peer node exists (e.g., at least one peer node is not identified, etc.) as determined at operation 425, the advertisement is discarded at operation 435.

When at least one peer node is identified as determined at operation 425, the advertisement is sent or routed to the identified peer nodes at operation 430. Further, the advertising node may adapt or modify the polytope boundaries in an advertisement to be specific for a peer node. By way of example, the advertising node may determine an intersection of the semantic ranges for a peer node and the polytope boundaries of the advertising node (e.g., minimum for the respective lowest and highest values for each dimension in the advertised polytope boundaries within the semantic ranges) to produce a resulting semantic range for the advertisement. This defines the semantic space where question forwarding is supported from the receiving node to the advertising node. The advertising node may update the advertisement for a peer node to include the intersection (e.g., the advertising node may advertise a specific knowledge within the semantic range for a peer node, where the intersection represents this knowledge (or subset of the semantic range)).

The peer nodes may process the advertisement in substantially the same manner described above (FIG. 3). For example, the receiving node may update the routing information to reflect the region boundaries of the advertising node indicating the advertised skills or capabilities. This enables the receiving node to route requests encompassed by the region boundaries to the advertising node.

Once the advertisement has been sent at operations 430, 440, or discarded at operation 435, the above process repeats from operation 405 until the advertisements have been processed as determined at operation 445.

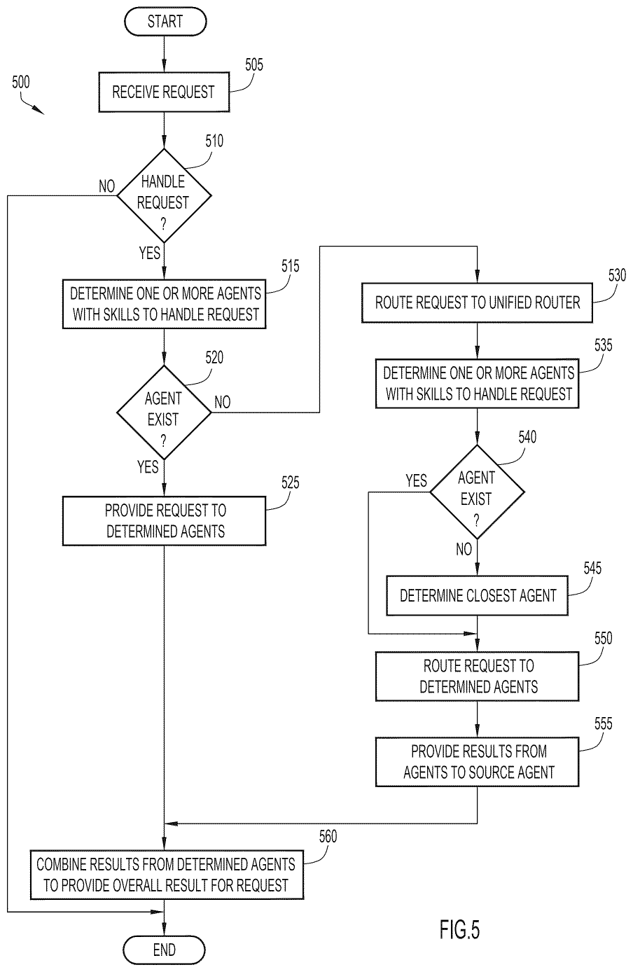

With continued reference to FIGS. 1-4 , FIG. 5 illustrates a flowchart of a method 500 for determining agents to process requests, according to an example embodiment. This may correspond to operations 220 and 225 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above. Agents 110 dynamically register their skills with other agents and/or unified router 140 in substantially the same manner described above (e.g., an agent 110 providing bounds of the corresponding region in the vector space to another agent and/or unified router 140). Unified router 140 may dynamically advertise or register the skills or capabilities of associated agents (and/or unified routers) with other agents and/or unified routers in substantially the same manner described above (e.g., a unified router 140 providing bounds of the corresponding regions (e.g., actual or aggregated) in the vector space to peer (or neighboring) agents 110 and/or unified routers 140). The regions of the skills or capabilities of an agent or unified router combined with received regions indicate the region in the vector space for which the agent or unified router can handle requests or questions.

A user request from an end-user device 105 is received at a source agent 120 at operation 505, and semantic router 112 of source agent 120 analyzes the request to determine one or more agents (e.g., source agent 120 and target agents 130), registered with or known to the source agent, with sufficient skills or capabilities to process the request. For example, semantic router 112 of source agent 120 determines an embedding of the request (intent and context) mapped to the vector space, and compares the request embedding to the boundaries of the region indicating the questions or requests that can be handled by source agent 120. When the request embedding resides outside the region indicating the requests or questions handled by the source agent at operation 510 (e.g., the source agent cannot handle the request, etc.), the request is ignored or discarded and the process terminates.

When the request embedding resides within the region indicating the requests or questions handled by the source agent at operation 510 (e.g., the source agent can handle the request, etc.), semantic router 112 of source agent 120 identifies potential regions within the vector space for the source agent and/or target agents 130 advertising to (or registered with) the source agent that encompass or contain the embedding of the request at operation 515. This may be accomplished by comparing the request embedding (corresponding to coordinates in the vector space) to boundaries of the regions (corresponding to source and target agents) provided during skills advertisement (or registration) and/or known to the source agent in substantially the same manner described above.

In addition, there may be scenarios where the request embedding is contained within more than one region due to overlapping. In this case, a selection technique may be employed to identify an appropriate region and corresponding source agent 120 and/or target agent 130. For example, each of agents 120, 130 associated with the regions containing the request embedding may be selected (e.g., the request may be routed or sent (multicast) to each of those agents). Further, the region having the closest or most explicit match may be selected. This may be determined based on any conventional or other distances of the request embedding to portions of the region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

When at least one agent exists (e.g., at least one region is identified, etc.) as determined at operation 520, semantic router 112 of source agent 120 provides the request to the agents corresponding to the identified regions at operation 525. For example, when the region of source agent 120 is identified, the source agent may process the request (e.g., via LLM 116 of source agent 120) to produce results. In the event, one or more regions of target agents 130 advertising to (or registered with) source agent 120 are identified, semantic router 112 of source agent 120 directly routes or sends the request to the target agents associated with the one or more identified regions to process the request (e.g., via corresponding LLMs 116 of the target agents). The results of the request from the target agents 130 are returned to source agent 120.

Source agent 120 combines the results from the identified agents at operation 560 to produce an overall result for the request that is provided to end-user device 105. For example, the results of the agents may be aggregated, collated, joined, merged, or otherwise combined or formatted to produce the overall result. By way of example, a request may be provided to agents 110 with different specialties that may produce varying information for the request. Source agent 120 extracts the appropriate information (e.g., may ignore duplicate or cumulative information, identify relevant information for the request, etc.) from the agent results via any conventional or other techniques to produce the overall result.

When no agent exists (e.g., no region is identified that contains the embedding of the request, etc.) as determined at operation 520, semantic router 112 of source agent 120 routes or sends the request to unified router 140 at operation 530. In an embodiment, unified router 140 preferably has advertisements or registrations for all or a large quantity of target agents in framework 100. In this case, unified router 140 identifies one or more target agents 130 with sufficient skills or capabilities to process the request at operation 535. For example, unified router 140 determines an embedding of the request (intent and context) mapped to the vector space. The intent and context of the request may be determined using any conventional or other natural language processing (NLP) techniques. Alternatively, unified router 140 may receive the embedding from source agent 120. Unified router 140 identifies potential regions within the vector space for target agents 130 that encompass or contain the embedding of the request. This may be accomplished by comparing the request embedding (corresponding to coordinates in the vector space) to boundaries of the regions corresponding to target agents 130 provided during registration in substantially the same manner described above.

In addition, there may be scenarios where the request embedding is contained within more than one region due to overlapping. In this case, a selection technique may be employed to identify an appropriate region and corresponding target agent 130. For example, each of the target agents associated with the regions containing the request embedding may be selected (e.g., the request may be routed or sent (multicast) to each of those target agents). Further, the region having the closest or most explicit match may be selected. This may be determined based on any conventional or other distances of the request embedding to portions of a region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

When no agent exists (e.g., no region is identified, etc.) as determined at operation 540, unified router 140 identifies a closest or nearest region to the embedding of the request at operation 545. This may be determined based on a shortest distance in the vector space between the request embedding and one or more boundaries of the regions using any conventional or other techniques (e.g., Euclidean or other distance metrics, cosine similarity, etc.).

Once the regions are identified, unified router 140 routes or sends the request to target agents 130 corresponding to the identified regions at operation 550 to process the request (e.g., via corresponding LLMs 116 of the target agents). The results of the request from the target agents are returned to unified router 140 and provided to source agent 120 at operation 555. Source agent 120 combines the results from the identified agents at operation 560 to produce an overall result for the request that is provided to end-user device 105 in substantially the same manner described above.

In an embodiment, unified router 140 may include one or more DNS servers or other directory systems as described above. Unified router 140 may filter incoming and/or outgoing advertisements in substantially the same manner described above to maintain region boundaries and IP addresses (and/or other information) for agents 110. Source agent 120 may send the request to unified router 140 based on the request embedding residing within advertised polytope ranges for the unified router (indicating skills or capabilities of associated target agents) at operation 530. Unified router 140 receives the request from source agent 120 and identifies one or more regions in the vector space at operations 535, 540, and 545 in substantially the same manner described above. The regions may be associated with other DNS servers or directory systems, thereby enabling the request to traverse these systems until reaching a system with associated target agents capable of handling the request. The traversal may be based on a comparison of the request embedding to advertised polytope ranges of the DNS servers or other directory systems (e.g., routed to a next system associated with a polytope range encompassing the request embedding). The system with associated target agents capable of handling the request identifies one or more regions in the vector space at operations 535, 540, and 545 in substantially the same manner described above.

Unified router 140 provides information for the target agents associated with the one or more identified regions (e.g., IP or other network address, agent identity, corresponding region or polytope, etc.) to source agent 120. The source agent routes or sends the request to the target agents 130 based on the information from unified router 140 to process the request (e.g., via corresponding LLMs 116 of the target agents) at operation 550. Alternatively, unified router 140 may route the requests to the target agents associated with the one or more identified regions. The results of the request are returned from target agents 130 to source agent 120 at operation 555 in substantially the same manner described above. Alternatively, the target agents may provide the response to unified router 140 for forwarding to source agent 120, when unified router 140 routes the request. The results from the identified agents (or unified router 140) are combined by source agent 120 at operation 560 in substantially the same manner described above to produce an overall result that is provided to end-user device 105 in response to the request.

In an embodiment, framework 100 may include agents 110 and unified router 140 in a wide area network environment and advertise the skills or capabilities via a network routing protocol configured for semantic routing as described above. Unified router 140 may filter incoming and/or outgoing advertisements in substantially the same manner described above. In this case, the network routing protocol enables multi-hop routing of requests from a source agent to target agents within the same or different domains. Further, unified router 140 may aggregate the region boundaries received in advertisements from associated agents 110 within a domain to produce a summary for advertising to external domains having their own unified routers (e.g., to hide identities of the agents from external domains which have a lesser level of trust) in substantially the same manner described above.

The network routing protocol may be any conventional or other routing protocol (e.g., Border Gateway Protocol (BGP), Open Shortest Path First (OSPF), Interior Gateway Protocol (IGP), Intermediate System to Intermediate System, etc.) adapted or modified for semantic routing (e.g., advertises polytope boundaries representing skills or capabilities of the agents instead of, or in addition to, IP or other addresses) as described above. By way of example, a BGP-based protocol may be used to advertise routes to answer specific questions via the range based polytopes in substantially the same manner described above. By way of further example, an OSPF-based network routing protocol may be employed in substantially the same manner described above. In addition, an embodiment may employ plural network routing protocols. A mix of BGP, OSPF, and other network routing protocol mechanisms may be employed to interchange polytope information at protocol peering points. This enables mixing of the strengths of the network routing protocols. For example, a first (e.g., BGP-based, etc.) protocol may be employed for inter-domain routing, while a second (e.g., OSPF-based, Intermediate System to Intermediate System-based, IGP-based, etc.) protocol may be used for intra-domain routing in substantially the same manners described above.

Source agent 120 may send the request to unified router 140 based on the request embedding residing within advertised (actual or aggregated) polytope ranges for the unified router (indicating skills or capabilities of associated target agents) at operation 530. Unified router 140 receives the request from source agent 120 and identifies one or more regions in the vector space at operations 535, 540, and 545 in substantially the same manner described above. The regions may be associated with other unified routers or agents, thereby enabling the request to traverse multiple hops until reaching a unified router (or agent) with associated (or peer) target agents capable of handling the request. The traversal may be based on a comparison of the request embedding to advertised polytope ranges of the unified routers and agents (e.g., routed to a next hop associated with a polytope range encompassing the request embedding). The unified router (or agent) with associated (or peer) target agents capable of handling the request identifies one or more regions in the vector space at operations 535, 540, and 545 in substantially the same manner described above.

Unified router 140 routes or sends the request to the target agents associated with the one or more identified regions to process the request (e.g., via corresponding LLMs 116 of the target agents) at operation 550 in substantially the same manner described above. The results of the request are returned from target agents 130 to source agent 120 at operation 555 in substantially the same manner described above. Alternatively, the target agents may provide the response to unified router 140 for forwarding to source agent 120. The results from the identified agents (or unified router 140) are combined by source agent 120 at operation 560 in substantially the same manner described above to produce an overall result that is provided to end-user device 105 in response to the request.

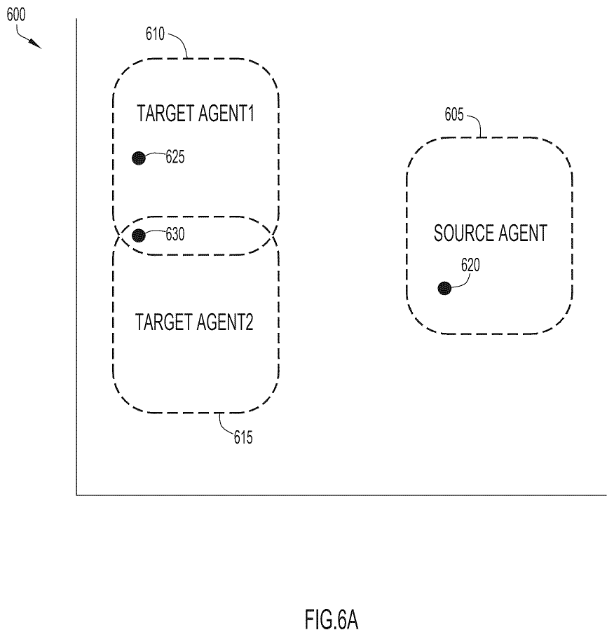

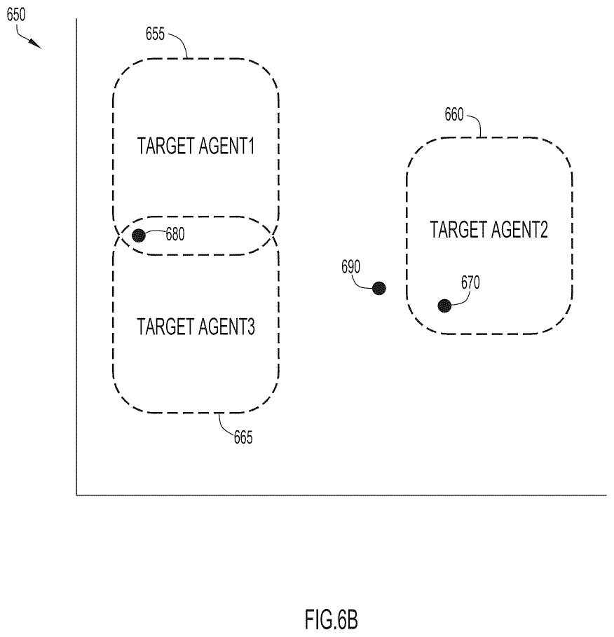

With continued reference to FIGS. 1-5 , FIG. 6A illustrates an example vector space 600 for a source agent 120 for determining agents to process requests, according to an example embodiment. Initially, vector space 600 includes dimensions corresponding to the dimensions of embeddings of requests and agent intents and contexts. The collective (intent, context) embeddings of source agent 120 (e.g., SOURCE AGENT as viewed in FIG. 6A) and each target agent 130 (e.g., TARGET AGENT1 and TARGET AGENT2 as viewed in FIG. 6A) occupy a corresponding discrete region in the vector space. By way of example, vector space 600 includes a region 605 corresponding to source agent 120, a region 610 corresponding to TARGET AGENT1 registered with source agent 120, and a region 615 corresponding to TARGET AGENT2 registered with source agent 120. Accordingly, each region 605, 610, 615 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Source agent 120 may receive a request and determine an embedding 620 of the request (intent and context) mapped to vector space 600 in substantially the same manner described above. Semantic router 112 of source agent 120 identifies region 605 that encompasses or contains embedding 620 of the request (based on a comparison of the request embedding to boundaries of regions 610, 615 of vector space 600 provided during registration and to boundaries of region 605 known to the source agent) in substantially the same manner described above. Since region 605 corresponds to source agent 120, the source agent may process the request to produce results in substantially the same manner described above.

Source agent 120 may receive another request and determine an embedding 625 of the request (intent and context) mapped to vector space 600 in substantially the same manner described above. Semantic router 112 of the source agent identifies region 610 that encompasses or contains embedding 625 of the request (based on a comparison of the request embedding to boundaries of regions 610, 615 of vector space 600 provided during registration and to boundaries of region 605 known to the source agent). Since region 610 corresponds to TARGET AGENT1, semantic router 112 of source agent 120 directly routes or sends the request to TARGET AGENT1 to process the request (e.g., via corresponding LLM 116) in substantially the same manner described above. The results of the request from TARGET AGENT1 are returned to source agent 120 to provide results for the request in substantially the same manner described above.

Source agent 120 may receive yet another request and determine an embedding 630 of the request (intent and context) mapped to vector space 600 in substantially the same manner described above. Semantic router 112 of source agent 120 identifies regions 610 and 615 that each encompass or contain embedding 630 of the request (based on a comparison of the request embedding to boundaries of regions 610, 615 of vector space 600 provided during registration and to boundaries of region 605 known to the source agent) in substantially the same manner described above. Since regions 610, 615 correspond to TARGET AGENT1 and TARGET AGENT2, semantic router 112 of source agent 120 directly routes or sends the request to TARGET AGENT1 and TARGET AGENT2 to process the request (e.g., via corresponding LLMs 116) in substantially the same manner described above. The results of the request from TARGET AGENT1 and TARGET AGENT2 are returned to source agent 120 to provide results for the request in substantially the same manner described above.

In the event that the embedding of a request resides outside the regions of vector space 600 (e.g., corresponding to source agent 120 and target agents 130 registered with the source agent), the request is routed or sent by semantic router 112 of source agent 120 to unified router 140. Since unified router 140 preferably has registrations for all target agents 130 (or for a greater quantity of target agents than source agent 120), unified router 140 identifies one or more target agents 130 to process the request. With continued reference to FIGS. 1-5 and 6A , FIG. 6B illustrates an example vector space 650 for unified router 140 for determining agents to process requests, according to an example embodiment. Initially, vector space 650 includes dimensions corresponding to the dimensions of embeddings of requests and agent intents and contexts. The collective (intent, context) embeddings of each target agent 130 (e.g., TARGET AGENT1,TARGET AGENT2, and TARGET AGENT3 as viewed in FIG. 6B) occupy a corresponding discrete region in the vector space. By way of example, vector space 650 includes a region 655 corresponding to TARGET AGENT1, a region 660 corresponding to TARGET AGENT2, and a region 665 corresponding to TARGET AGENT3. Accordingly, each region 655, 660, 665 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Unified router 140 may receive a request from source agent 120 and determine an embedding 670 of the request (intent and context) mapped to vector space 650 in substantially the same manner described above. Alternatively, the unified router may receive embedding 670 from source agent 120 in substantially the same manner described above. Unified router 140 identifies region 660 that encompasses or contains embedding 670 of the request (based on a comparison of the request embedding to boundaries of the regions of vector space 650 provided during registration) in substantially the same manner described above. Since region 660 corresponds to TARGET AGENT2, unified router 140 routes or sends the request to TARGET AGENT2 to process the request (e.g., via corresponding LLM 116) in substantially the same manner described above. The results of the request from TARGET AGENT2 are returned to unified router 140 and provided to source agent 120 to produce results for the request in substantially the same manner described above.

Unified router 140 may receive another request from source agent 120 and determine an embedding 680 of the request (intent and context) mapped to vector space 650 in substantially the same manner described above. Alternatively, unified router 140 may receive embedding 680 from source agent 120 in substantially the same manner described above. The unified router identifies regions 655 and 665 that each encompass or contain embedding 680 of the request (based on a comparison of the request embedding to boundaries of the regions of vector space 650 provided during registration) in substantially the same manner described above. Since regions 655, 665 correspond to TARGET AGENT1 and TARGET AGENT3, unified router 140 routes or sends the request to TARGET AGENT1 and TARGET AGENT3 to process the request (e.g., via corresponding LLMs 116) in substantially the same manner described above. The results of the request from TARGET AGENT1 and TARGET AGENT3 are returned to unified router 140 and provided to source agent 120 to produce results for the request in substantially the same manner described above.

Unified router 140 may receive yet another request from source agent 120 and determine an embedding 690 of the request (intent and context) mapped to vector space 650 in substantially the same manner described above. Alternatively, unified router 140 may receive embedding 690 from source agent 120 in substantially the same manner described above. Since embedding 690 resides outside regions 655, 660, 665 of vector space 650, unified router 140 is unable to initially identify a target agent to process the request (based on a comparison of the request embedding to boundaries of the regions of vector space 650 provided during registration). In this case, unified router 140 identifies a closest or nearest region to embedding 690. This may be determined based on a shortest distance in vector space 650 between embedding 690 and one or more boundaries of regions 655, 660, 665 using any conventional or other techniques (e.g., Euclidean or other distance metrics, cosine similarity, etc.) in substantially the same manner described above.

By way of example, embedding 690 may be closest to region 660 (e.g., as viewed in FIG. 6B). Since region 660 corresponds to TARGET AGENT2, unified router 140 routes or sends the request to TARGET AGENT2 to process the request (e.g., via corresponding LLM 116) in substantially the same manner described above. The results of the request from TARGET AGENT2 are returned to unified router 140 and provided to source agent 120 to produce results for the request in substantially the same manner described above.

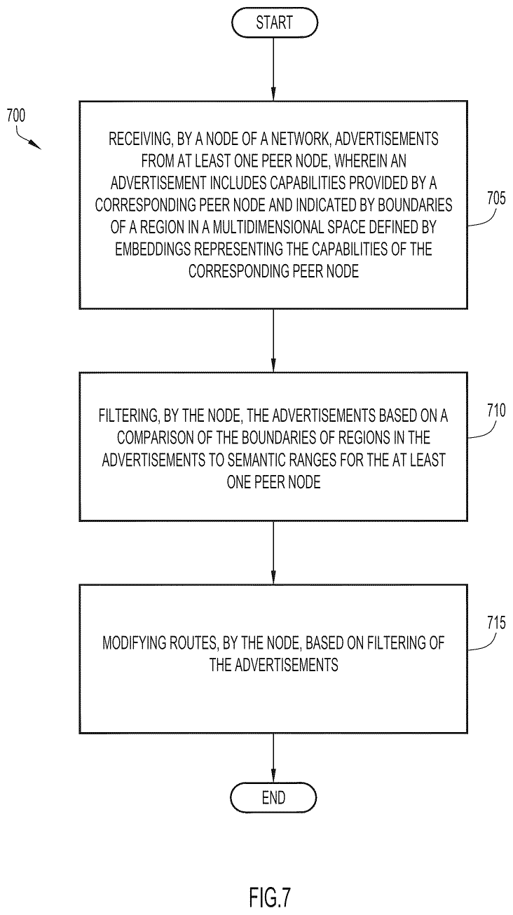

FIG. 7 is a flowchart of an example method 700 for routing requests to corresponding agents, according to an example embodiment. At operation 705, a node of a network receives advertisements from at least one peer node. An advertisement includes capabilities provided by a corresponding peer node and indicated by boundaries of a region in a multidimensional space defined by embeddings representing the capabilities of the corresponding peer node. At operation 710, the node filters the advertisements based on a comparison of the boundaries of regions in the advertisements to semantic ranges for the at least one peer node. At operation 715, the node modifies routes based on filtering of the advertisements.

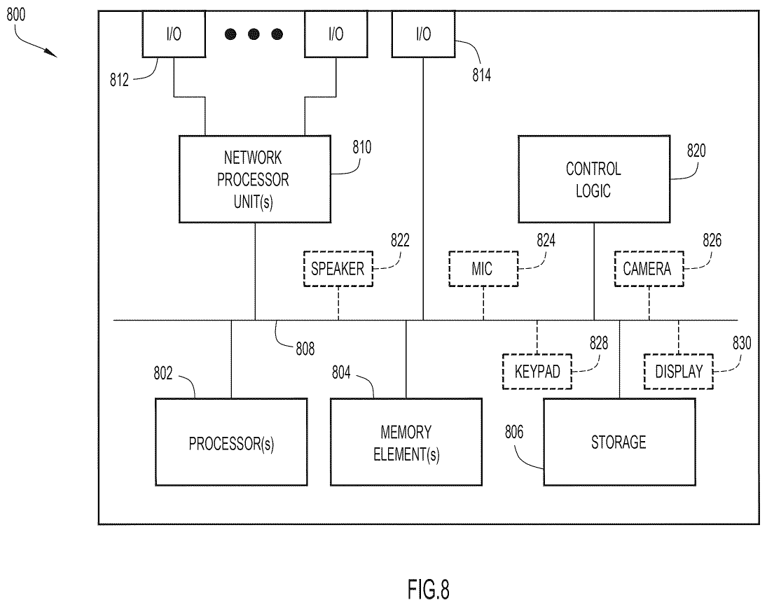

Referring to FIG. 8, FIG. 8 illustrates a hardware block diagram of a computing device 800 that may perform functions associated with operations discussed herein in connection with the techniques depicted in FIGS. 1-5, 6A, 6B , and 7. In various embodiments, a computing device or apparatus or system, such as computing device 800 or any combination of computing devices 800, may be configured as any device entity/entities (e.g., network nodes, computer devices, end-user devices, servers, client devices, communication devices, network devices, processors, switching devices, network interfaces, agents, unified or other routers, etc.) as discussed for the techniques depicted in connection with FIGS. 1-5, 6A, 6B , and 7 in order to perform operations of the various techniques discussed herein.

In at least one embodiment, computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interfaces 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, network device, network nodes, processors, network interfaces, switching devices, agents, unified or other routers, etc.), computing device 800 may further include, or be coupled to, a speaker 822 to convey sound, microphone or other sound sensing device 824, camera or image capture device 826, a keypad or keyboard 828 to enter information (e.g., alphanumeric information, etc.), and/or a touch screen or other display 830. These items may be coupled to bus 808 or I/O interface(s) 814 to transfer data with other elements of computing device 800.

In various embodiments, control logic 820 can include instructions that, when executed, cause processor(s) 802 to perform operations, which can include, but not be limited to, providing overall control operations of computing device 800; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

Present embodiments may provide various technical and other advantages. In an embodiment, network routing is performed to direct a request to appropriate agents for processing based on semantic correlation of a request intent to agent skills or capabilities which increases throughput and performance for handling requests and avoids re-routing and re-processing of requests. This also reduces consumption of processing and memory/storage resources to improve computing performance and network routing.

In an embodiment, the machine learning models (and/or LLM prompts) may be continuously updated (or trained) based on feedback related to results of the agents. For example, an agent may return a poor result (e.g., based on various metrics, etc.). The feedback may be used to update or train the machine learning models (or LLM prompts) to decrease the confidence of that response, and/or to avoid routing to that agent for similar requests. A similar approach may be used for a good result, where the feedback may be used to update or train the machine learning models (or LLM prompts) to increase the confidence of that response, and/or increase routing to that agent for similar requests. Thus, the machine learning models (or LLM prompts) may continuously evolve (or be trained) to learn to produce appropriate responses, and/or routing may be updated as requests are processed.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory elements 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving, by a node of a network, advertisements from at least one peer node, wherein an advertisement includes capabilities provided by a corresponding peer node and indicated by boundaries of a region in a multidimensional space defined by embeddings representing the capabilities of the corresponding peer node; filtering, by the node, the advertisements based on a comparison of the boundaries of regions in the advertisements to semantic ranges for the at least one peer node; and modifying routes, by the node, based on filtering of the advertisements.

In one example, nodes of the network include artificial intelligence agents and the region for the corresponding peer node is defined by a set of embeddings of intents and contexts for the corresponding peer node, wherein the set of embeddings includes ranges for each dimension, and wherein the corresponding peer node is identified to process a request based on dimensions of an embedding of the request being within the ranges of the set of embeddings for the region for the corresponding peer node.

In one example, filtering the advertisements comprises defining a subset of the multidimensional space for which corresponding requests are to be routed to peer nodes, and determining an intersection of the subset and boundaries of the region received in the advertisement from the corresponding peer node.

In one example, the method further comprises sending, by the node, an advertisement to one or more peer nodes determined based on semantic ranges for the one or more peer nodes.

In one example, the semantic ranges for peer nodes are provided from one or more central authorities according to a policy.

In one example, filtering the advertisements comprises verifying the corresponding peer node has capabilities corresponding to the boundaries of the region advertised by the corresponding peer node based on capabilities asserted by one or more external authorities.

In one example, wherein filtering the advertisements comprises filtering the advertisements based on a cost for the at least one peer node to handle a request.

In another form, an apparatus is provided. The apparatus comprises a node of a network to enable communications; memory; and at least one processor configured to perform operations including: receiving advertisements from at least one peer node, wherein an advertisement includes capabilities provided by a corresponding peer node and indicated by boundaries of a region in a multidimensional space defined by embeddings representing the capabilities of the corresponding peer node; filtering the advertisements based on a comparison of the boundaries of regions in the advertisements to semantic ranges for the at least one peer node; and modifying routes based on filtering of the advertisements.

In another form, one or more non-transitory computer readable storage media are provided. The one or more non-transitory computer readable storage media are encoded with processing instructions that, when executed by one or more processors of a node of a network, cause the one or more processors to perform operations including: receiving advertisements from at least one peer node, wherein an advertisement includes capabilities provided by a corresponding peer node and indicated by boundaries of a region in a multidimensional space defined by embeddings representing the capabilities of the corresponding peer node; filtering the advertisements based on a comparison of the boundaries of regions in the advertisements to semantic ranges for the at least one peer node; and modifying routes based on filtering of the advertisements.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

1. A method comprising:
receiving, by a node of a network, advertisements from at least one peer node, wherein an advertisement includes capabilities provided by a corresponding peer node and indicated by boundaries of a region in a multidimensional space defined by embeddings representing the capabilities of the corresponding peer node, and wherein the region for the corresponding peer node is defined by a set of embeddings of intents and contexts for the corresponding peer node that includes ranges for each dimension;
filtering, by the node, the advertisements based on a comparison of the boundaries of regions in the advertisements to semantic ranges for the at least one peer node;
modifying routes, by the node, based on filtering of the advertisements;
identifying, by the node, the corresponding peer node to process a request based on dimensions of an embedding of the request being within the ranges of the set of embeddings for the region for the corresponding peer node indicated in the advertisements;
routing, by the node, the request to the corresponding peer node to process the request based on the routes modified by the advertisements; and
providing, by the node, results to the request received from the corresponding peer node on a user interface.

2. The method of claim 1, wherein nodes of the network include artificial intelligence agents.

3. The method of claim 1, wherein filtering the advertisements comprises:
defining a subset of the multidimensional space for which corresponding requests are to be routed to peer nodes; and
determining an intersection of the subset and boundaries of the region received in the advertisement from the corresponding peer node.

4. The method of claim 1, further comprising:
sending, by the node, an advertisement to one or more peer nodes determined based on semantic ranges for the one or more peer nodes.

5. The method of claim 1, wherein the semantic ranges for peer nodes are provided from one or more central authorities according to a policy.

6. The method of claim 1, wherein filtering the advertisements comprises:
verifying the corresponding peer node has capabilities corresponding to the boundaries of the region advertised by the corresponding peer node based on capabilities asserted by one or more external authorities.

7. The method of claim 1, wherein filtering the advertisements comprises:
filtering the advertisements based on a cost for the at least one peer node to handle a request.

8. An apparatus comprising:
a node of a network to enable communications;
memory; and
at least one processor configured to perform operations including:
receiving advertisements from at least one peer node, wherein an advertisement includes capabilities provided by a corresponding peer node and indicated by boundaries of a region in a multidimensional space defined by embeddings representing the capabilities of the corresponding peer node, and wherein the region for the corresponding peer node is defined by a set of embeddings of intents and contexts for the corresponding peer node that includes ranges for each dimension;
filtering the advertisements based on a comparison of the boundaries of regions in the advertisements to semantic ranges for the at least one peer node;
modifying routes based on filtering of the advertisements;
identifying the corresponding peer node to process a request based on dimensions of an embedding of the request being within the ranges of the set of embeddings for the region for the corresponding peer node indicated in the advertisements;
routing the request to the corresponding peer node to process the request based on the routes modified by the advertisements; and
providing results to the request received from the corresponding peer node on a user interface.

9. The apparatus of claim 8, wherein nodes of the network include artificial intelligence agents.

10. The apparatus of claim 8, wherein filtering the advertisements comprises:
defining a subset of the multidimensional space for which corresponding requests are to be routed to peer nodes; and
determining an intersection of the subset and boundaries of the region received in the advertisement from the corresponding peer node.

11. The apparatus of claim 8, wherein the at least one processor is further configured to perform operations including:
sending an advertisement to one or more peer nodes determined based on semantic ranges for the one or more peer nodes.

12. The apparatus of claim 8, wherein the semantic ranges for peer nodes are provided from one or more central authorities according to a policy.

13. The apparatus of claim 8, wherein filtering the advertisements comprises:
verifying the corresponding peer node has capabilities corresponding to the boundaries of the region advertised by the corresponding peer node based on capabilities asserted by one or more external authorities; and
filtering the advertisements based on a cost for the at least one peer node to handle a request.

14. One or more non-transitory computer readable storage media encoded with processing instructions that, when executed by one or more processors of a node of a network, cause the one or more processors to perform operations including:
receiving advertisements from at least one peer node, wherein an advertisement includes capabilities provided by a corresponding peer node and indicated by boundaries of a region in a multidimensional space defined by embeddings representing the capabilities of the corresponding peer node, and wherein the region for the corresponding peer node is defined by a set of embeddings of intents and contexts for the corresponding peer node that includes ranges for each dimension;
filtering the advertisements based on a comparison of the boundaries of regions in the advertisements to semantic ranges for the at least one peer node;
modifying routes based on filtering of the advertisements;
identifying the corresponding peer node to process a request based on dimensions of an embedding of the request being within the ranges of the set of embeddings for the region for the corresponding peer node indicated in the advertisements;
routing the request to the corresponding peer node to process the request based on the routes modified by the advertisements; and
providing results to the request received from the corresponding peer node on a user interface.

15. The one or more non-transitory computer readable storage media of claim 14, wherein nodes of the network include artificial intelligence agents.

16. The one or more non-transitory computer readable storage media of claim 14, wherein filtering the advertisements comprises:
defining a subset of the multidimensional space for which corresponding requests are to be routed to peer nodes; and
determining an intersection of the subset and boundaries of the region received in the advertisement from the corresponding peer node.

17. The one or more non-transitory computer readable storage media of claim 14, wherein the processing instructions further cause the one or more processors to perform operations including:
sending an advertisement to one or more peer nodes determined based on semantic ranges for the one or more peer nodes.

18. The one or more non-transitory computer readable storage media of claim 14, wherein the semantic ranges for peer nodes are provided from one or more central authorities according to a policy.

19. The one or more non-transitory computer readable storage media of claim 14, wherein filtering the advertisements comprises:
verifying the corresponding peer node has capabilities corresponding to the boundaries of the region advertised by the corresponding peer node based on capabilities asserted by one or more external authorities.

20. The one or more non-transitory computer readable storage media of claim 14, wherein filtering the advertisements comprises:
filtering the advertisements based on a cost for the at least one peer node to handle a request.
